(19) United States
(12) Patent Application Publication
(10) Pub. No.: US 2026/0006652 A1
(43) Pub. Date: Jan. 1, 2026

(54) COMMUNICATION DEVICE AND NON-TRANSITORY COMPUTER-READABLE RECORDING MEDIUM STORING COMPUTER-READABLE INSTRUCTIONS FOR TERMINAL DEVICE

(71) Applicant: BROTHER KOGYO KABUSHIKI KAISHA, Nagoya (JP)

(72) Inventor: Hiroshi SHIBATA, Yatomi (JP)

(21) Appl. No.: 19/248,568

(22) Filed: Jun. 25, 2025

(30) Foreign Application Priority Data
Jun. 27, 2024 (JP) 2024-104262

(51) Int. Cl. H04W 76/10; H04W 12/069; H04W 64/00; H04W 84/12

(52) U.S. Cl. CPC H04W 76/10; H04W 12/069; H04W 64/006; H04W 84/12

(57) ABSTRACT

A communication device may be configured to: send capable information indicating that the communication device is capable of using a DPP scheme to a terminal device according to a Wi-Fi Aware scheme; send relation information related to a public key of the communication device conforming to the DPP scheme to the terminal device according to the Wi-Fi Aware scheme; execute a first communication with the terminal device according to the DPP scheme after the capable information and the relation information have been sent to the terminal device, the first communication including a communication of connection information from the terminal device to the communication device; and in a case where the connection information is received from the terminal device, establish a first wireless connection between the communication device and an external device via the Wi-Fi interface by using the connection information.

### REFERENCE TO RELATED APPLICATION

This application claims priority to Japanese Patent Application No. 2024-104262 filed on Jun. 27, 2024. The entire content of the priority application is incorporated herein by reference.

### BACKGROUND ART

A technology is known for sending communication parameters to a communication device in response to receiving from the communication device an authentication request conforming to the Device Provisioning Protocol (DPP) scheme. The communication parameters are used for the communication device to join a wireless network.

### SUMMARY

The disclosure herein provides a novel technology for establishing a wireless connection between a communication device and an external device according to the DPP scheme.

Disclosed herein is a communication device including a Wi-Fi interface and a controller. The controller may be configured to send capable information indicating that the communication device is capable of using a Device Provisioning Protocol (DPP) scheme of a Wi-Fi standard to a terminal device via the Wi-Fi interface according to a Wi-Fi Aware scheme of the Wi-Fi standard. The controller may be configured to send relation information related to a public key of the communication device conforming to the DPP scheme to the terminal device via the Wi-Fi interface according to the Wi-Fi Aware scheme. The controller may be configured to execute a first communication with the terminal device according to the DPP scheme after the capable information has been sent to the terminal device and the relation information has been sent to the terminal device. The first communication may include a communication of an authentication request obtained by using the public key from the terminal device to the communication device, a communication of an authentication response from the communication device to the terminal device, and a communication of connection information from the terminal device to the communication device. The controller may be configured to, in a case where the connection information is received from the terminal device, establish a first wireless connection between the communication device and an external device via the Wi-Fi interface by using the connection information.

According to the above configuration, the communication device sends the capable information indicating that the communication device is capable of using the DPP scheme to the terminal device according to the Wi-Fi Aware scheme. The terminal device can thus recognize that the communication device is capable of executing communications according to the DPP scheme. Further, the communication device sends the relation information related to the public key of the communication device conforming to the DPP scheme to the terminal device according to the Wi-Fi Aware scheme and executes the first communication with the terminal device according to the DPP scheme. As a result, the first wireless connection can be established according to the DPP scheme between the communication device and the external device.

Disclosed herein is another communication device including a Wi-Fi interface and a controller. The controller may be configured to send capable information indicating that the communication device is capable of using a Device Provisioning Protocol (DPP) scheme of a Wi-Fi standard to a terminal device via the Wi-Fi interface before a wireless connection of the Wi-Fi standard is established. The controller may be configured to send relation information related to a public key of the communication device conforming to the DPP scheme to the terminal device via the Wi-Fi interface. The controller may be configured to execute a first communication with the terminal device according to the DPP scheme via the Wi-Fi interface after the capable information has been sent to the terminal device and the relation information has been sent to the terminal device. The first communication may include a communication of an authentication request obtained by using the public key from the terminal device to the communication device, a communication of an authentication response from the communication device to the terminal device, and a communication of connection information from the terminal device to the communication device. The controller may be configured to, in a case where the connection information is received from the terminal device, establish a first wireless connection between the communication device and an external device via the Wi-Fi interface by using the connection information.

According to the above configuration, the communication device sends the capable information indicating that the communication device is capable of using the DPP scheme to the terminal device before a wireless connection of the Wi-Fi standard is established. The terminal device can thus recognize that the communication device is capable of executing communications according to the DPP scheme. Further, the communication device sends the relation information related to the public key of the communication device conforming to the DPP scheme to the terminal device and executes the first communication with the terminal device according to the DPP scheme. As a result, the first wireless connection can be established according to the DPP scheme between the communication device and the external device.

Also disclosed herein is a non-transitory computer-readable recording medium storing computer-readable instructions for a terminal device. The terminal device may include a Wi-Fi interface. The computer-readable instructions, when executed by a processor of the terminal device, may cause the terminal device to receive capable information indicating that a communication device is capable of using a Device Provisioning Protocol (DPP) scheme of a Wi-Fi standard from the communication device via the Wi-Fi interface according to a Wi-Fi Aware scheme of the Wi-Fi standard. The computer-readable instructions may cause the terminal device to receive relation information related to a public key of the communication device conforming to the DPP scheme from the communication device via the Wi-Fi-interface according to the Wi-Fi Aware scheme. The computer-readable instructions may cause the terminal device to execute a first communication with the communication device according to the DPP scheme after the capable information has been received from the communication device and the relation information has been received from the communication device. The first communication may include a communication of an authentication request obtained by using the public key from the terminal device to the communication device, a communication of an authentication response from the communication device to the terminal device, and a communication of connection information from the terminal device to the communication device. The connection information may be used for establishing a wireless connection between the communication device and an external device.

According to the above configuration, the terminal device receives the capable information indicating that the communication device is capable of using the DPP scheme from the communication device according to the Wi-Fi Aware scheme. The terminal device can thus recognize that the communication device is capable of executing communications according to the DPP scheme. Furter, the terminal device receives the relation information related to the public key of the communication device conforming to the DPP scheme according to the Wi-Fi Aware scheme and executes the first communication with the communication device according to the DPP scheme. As a result, the first wireless connection can be established according to the DPP scheme between the communication device and the external device.

Non-transitory computer-readable recording media storing computer-readable instructions for the above communication devices and methods carried out by the above communication devices are also novel and useful. Methods carried out by the above terminal are also novel and useful. Further, a system comprising the communication device(s) and the terminal device is also novel and useful.

### BRIEF DESCRIPTION OF DRAWINGS

FIG. 1 is a diagram showing a configuration of a communication system.

FIG. 2 is a sequence diagram.

FIG. 3 is a sequence diagram continued from FIG. 2.

FIG. 4 is a sequence diagram.

FIG. 5 is a sequence diagram continued from FIG. 4.

FIG. 6 is a sequence diagram

### DESCRIPTION

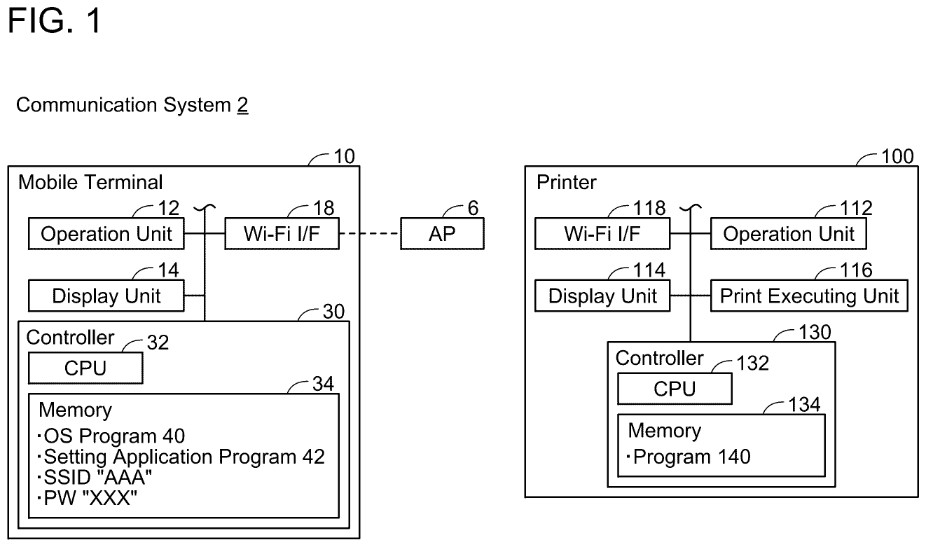

### Outline of Communication System 2: FIG. 1

As shown in FIG. 1, a communication system 2 comprises a mobile terminal 10, a printer 100, and an access point 6. Hereinafter, an access point is abbreviated as “AP”. This embodiment discloses a technology for allowing a user of the mobile terminal 10 to establish a wireless connection conforming to the Wi-Fi standard between the AP 6 and the printer 100 by using the terminal device 10. Hereinafter, a wireless connection conforming to the Wi-Fi standard is termed “Wi-Fi connection”.

### Configuration of Mobile Terminal 10

The mobile terminal 10 is a portable terminal device such as a smartphone, a tablet PC, a laptop PC, or the like. A stationary terminal device may be used instead of the mobile terminal 10. The mobile terminal 10 comprises an operation unit 12, a display unit 14, a Wi-Fi interface 18, and a controller 30. The units 12 to 30 are connected to a bus line. Hereinafter, an interface may be abbreviated as “I/F”.

The operation unit 12 is an I/F configured to allow the user to input various information to the mobile terminal 10 and comprises, for example, a touch screen and buttons. The display unit 14 is a display for displaying various information.

The Wi-Fi I/F 18 is a wireless interface for Wi-Fi communication conforming to the Wi-Fi standard. The Wi-Fi standard is a wireless communication scheme for wireless communications conforming to, for example, 802.11 standard established by the Institute of Electrical and Electronics Engineers, Inc. (IEEE) and standards complying therewith such as 802.11a, 11b, 11g, 11n, and 11ac. Especially, the Wi-Fi I/F 18 supports the Device Provisioning Protocol (DPP) scheme established by the Wi-Fi Alliance and the Wi-Fi Aware scheme established by the Wi-Fi Alliance. The DPP is detailed in the specification “Wi-Fi Easy Connect Specification Version 2.0” written by the Wi-Fi Alliance. The Wi-Fi Aware is detailed in the specification “Wi-Fi Aware Specification Version 4.0” written by the Wi-Fi Alliance. The Wi-Fi Aware is also referred to as Wi-Fi Neighbor Awareness Network (NAN).

The mobile terminal 10 can establish a Wi-Fi connection with the AP 6 by using a service set identifier (SSID) and a password of a wireless network formed by the AP 6. Hereinafter, a password may be abbreviated as “PW”.

In the Wi-Fi Aware scheme, each device first joins a Neighbor Awareness Network (NAN) cluster. Among the devices in the same NAN cluster, their Discovery Windows are synchronized. A Discovery Window is a time period during which signals are communicated.

Each device in the NAN cluster is assigned to a role of Master, Anchor Master, or Non-Master. A Master is capable of sharing timer information, searching for services, and inviting devices to the NAN cluster. An Anchor Master is capable of setting timer information for synchronization, in addition to the functions of the Master. A Non-Master is capable of sharing timer information and searching for services, but is incapable of inviting devices to the cluster.

Each device in the NAN cluster can search for other devices in the NAN cluster (more specifically, services provided by other devices). A signal for the service search is called a Subscribe. In response to receiving a Subscribe, a device sends a response signal called a Publish. In this embodiment, the mobile terminal 10 sends a Subscribe to search for other devices that can provide a DPP service. The DPP service is for establishing a wireless connection conforming to the DPP scheme of the Wi-Fi standard. The printer 100 is capable of using the DPP service. Thus, in response to receiving the Subscribe from the mobile terminal 10, the printer 100 sends the mobile terminal 10 a Publish indicating that the printer 100 is capable of using the DPP service. The mobile terminal 10 can thus find the printer 100 capable of using the DPP service.

The Subscribe and Publish described above are communicated by using lower layers than the network layer of the OSI model. That is, the above-described search is executed without using the network layer or upper layers of the OSI model. A pair of devices in the same NAN cluster is incapable of communications using the network layer or upper layers of the OSI model unless a connection is established therebetween.

The controller 30 comprises a CPU 32 and a memory 34. The memory 34 comprises a main storage and an auxiliary storage. The main storage includes, for example, a RAM, a cache memory, and the like. The auxiliary storage may be, for example, a flash memory, a solid state drive (SSD), or a ROM, or a combination thereof. An OS program 40 and a setting application program 42 are stored in the auxiliary storage. The CPU 32 implements various processes according to the programs 40, 42 loaded from the auxiliary storage to the main storage. Hereinafter, the OS program is abbreviated as “OS” and the setting application program is abbreviated as “app”.

An SSID “AAA” and a PW “XXX” are also stored in the memory 34. The SSID “AAA” and the PW “XXX” are information used in the wireless network formed by the AP 6.

The OS 40 controls basic operations of the mobile terminal 10. The app 42 causes the OS 40 to execute processes according to the Wi-Fi Aware scheme and the DPP scheme to establish a Wi-Fi connection between the AP 6 and the printer 100.

### Configuration of Printer 100

The printer 100 is a peripheral device, for example, a peripheral device of the mobile terminal 10, that is capable of executing a print function. In a modification, the printer 100 may be a multifunctional device capable of executing a scan function, a facsimile function, and the like in addition to the print function. The printer 100 comprises an operation unit 112, a display unit 114, a Wi-Fi I/F 118, a print executing unit 116, and a controller 130. The units 112 to 130 are connected to a bus line.

The operation unit 112 is an interface configured to allow the user to input various information to the printer 100 and comprises, for example, a touch screen and buttons. The display unit 114 is a display for displaying various information. As with the Wi-Fi I/F 18 of the mobile terminal 10, the Wi-Fi interface 118 supports the DPP scheme and the Wi-Fi Aware scheme. The print executing unit 116 comprises a print mechanism of, for example, inkjet scheme or laser scheme.

The controller 130 comprises a CPU 132 and a memory 134. The memory 134 comprises a main storage and an auxiliary storage. A program 140 is stored in the auxiliary storage. The CPU 132 implements various processes according to the program 140 loaded from the auxiliary storage to the main storage.

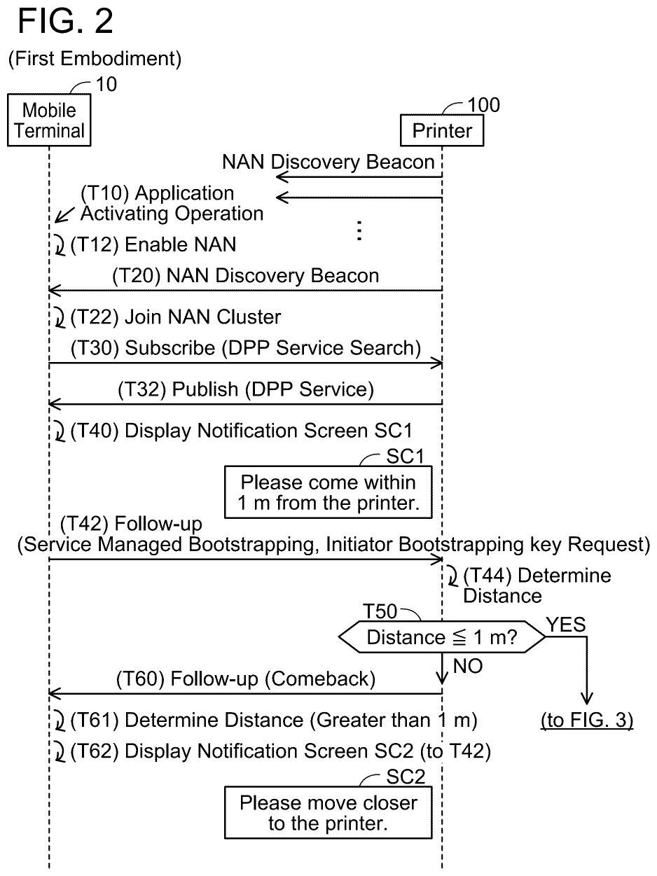

Referring now to FIG. 2, a process executed by the mobile terminal 10 and the printer 100 is described. Hereinafter, in order to facilitate understanding, actions of the CPU 32 of the mobile terminal 10 and the CPU 132 of the printer 100 are described as if the devices perform the actions, without describing them as actions of the CPUs. Further, since communications between the mobile terminal 10 and the printer 100 are executed via the Wi-Fi I/Fs 18 and 118, a phrase “via the Wi-Fi I/F” is omitted in communication-related descriptions in the following description.

In the initial state of the process in FIG. 2, the printer 100 belongs to a certain NAN cluster and is operating as an Anchor Master in the NAN cluster. Further, in the initial state of FIG. 2, the mobile terminal 10 is incapable of receiving signals conforming to the Wi-Fi Aware scheme because the app 42 is not activated yet. Here, “incapable of receiving signals conforming to the Wi-Fi Aware scheme” means that the Wi-Fi I/F 18 is in a state of not receiving signals conforming to the Wi-Fi Aware scheme. In a modification, “incapable of receiving signals conforming to the Wi-Fi Aware scheme” may mean that the Wi-Fi I/F 18 receives signals conforming to the Wi-Fi Aware scheme from an external device but the CPU 32 does not execute processes according to the signals (i.e., ignore the signals). Hereinafter, the state of being incapable of receiving signals conforming to the Wi-Fi Aware scheme is termed “NAN disabled state”.

The printer 100 sends a NAN Discovery Beacon frame (abbreviated as “Discovery”) by broadcasting. The Discovery is a signal conforming to the Wi-Fi Aware scheme that informs external devices of information related to the NAN cluster to which the printer 100 belongs. Devices out of the NAN cluster can join the NAN cluster when receiving the Discovery. That is, the Discovery can also be considered as a signal for inviting devices that are currently out of the NAN cluster into the NAN cluster. The printer 100 periodically sends the Discovery. Since the mobile terminal 10 is in the NAN disabled state in the initial state of FIG. 2, the mobile terminal 10 does not receive the Discovery from the printer 100.

In T10, the mobile terminal 10 receives an app activation operation from the user. In response, the mobile terminal 10 activates the app 42 and acts as below according to the app 42. Once the app 42 is activated, the mobile terminal 10 shifts from the NAN disabled state to a state of being capable of receiving signals conforming to the Wi-Fi Aware scheme. Here, “a state of being capable of receiving signals conforming to the Wi-Fi Aware scheme” means that the Wi-Fi I/F 18 can receive signals conforming to the Wi-Fi Aware scheme from external devices and the CPU 32 execute processes according to the signals. Hereinafter, the state of being capable of receiving signals conforming to the Wi-Fi Aware scheme is termed “NAN enabled state”.

In T20, the printer 100 sends a Discovery conforming to the Wi-Fi Aware scheme.

Since the mobile terminal 10 is in the NAN enabled state at the time of T20, the mobile terminal 10 receives the Discovery from the printer 100 and joins the NAN cluster in T22. Thus, the mobile terminal 10 and the printer 100 belong to the same NAN cluster. However, as described above, the mobile terminal 10 still cannot execute communications with the printer 100 by using the network layer or upper layers of the OSI model. That is, the mobile terminal 10 still does not belong to the Wi-Fi network to which the printer 100 belongs. Once the mobile terminal 10 has joined the NAN cluster, it executes communication with the printer 100 to decide its role in the NAN cluster, although this is not shown.

In T30, the mobile terminal 10 sends a Subscribe conforming to the Wi-Fi Aware scheme by broadcasting to devices within the NAN cluster. The Subscribe is a signal for searching for devices that provide the DPP service, and the printer 100 within the NAN cluster receives it.

In response to receiving the Subscribe from the mobile terminal 10 in T30, the printer 100 sends a Publish indicating that the printer 100 provides the DPP service to the mobile terminal 10 according to the Wi-Fi Aware scheme in T32.

By receiving the Publish from the printer 100 in T32, the mobile terminal 10 can find the printer 100 which provides the DPP service. If the mobile terminal 10 finds multiple printers including the printer 100 as printers that provide the DPP service, the mobile terminal 10 may display a screen for selection of a printer in which printing is to be executed from among the multiple printers. The following description assumes that the printer in which printing is to be executed is the printer 100.

In T40, the mobile terminal 10 displays a notification screen SC1 on the display unit 14. The notification screen SC1 prompts the user to move the mobile terminal 10 to within 1 meter from the printer 100. Thus, the user can approach the printer 100 with the mobile terminal 10 in possession.

At the same time as the display of the notification screen SC1, the mobile terminal 10 sends a wireless connection start request to the printer 100 by using a Follow-up conforming to the Wi-Fi Aware scheme in T42. This wireless connection start request is a start request for wireless connection conforming to the Wi-Fi Aware scheme. The Follow-up is a signal for sending additional information related to the DPP service to the printer 100 and includes Service Managed Bootstrapping information and Initiator Bootstrapping key Request. The Service Managed Bootstrapping information is necessary to start a wireless connection conforming to the Wi-Fi Aware scheme. Specifically, the Service Managed Bootstrapping information requests sending of information related to Bootstrapping of the DPP scheme. The Service Managed Bootstrapping information indicates a scheme for starting a connection. The Initiator Bootstrapping key Request requests sending of a Bootstrapping key (i.e., a public key). The Follow-up is a signal communicated by using lower layers than the network layer of the OSI model.

In response to receiving the Follow-up from the mobile terminal 10 in T42, the printer 100 determines the distance between the printer 100 and the mobile terminal 10 in T44. Specifically, the printer 100 identifies the signal strength of the received Follow-up and determines the distance between the mobile terminal 10 and the printer 100 based on the signal strength. More specifically, the printer 100 stores in advance a formula for determining a distance based on a signal strength and plugs the signal strength into the formula to determine the distance.

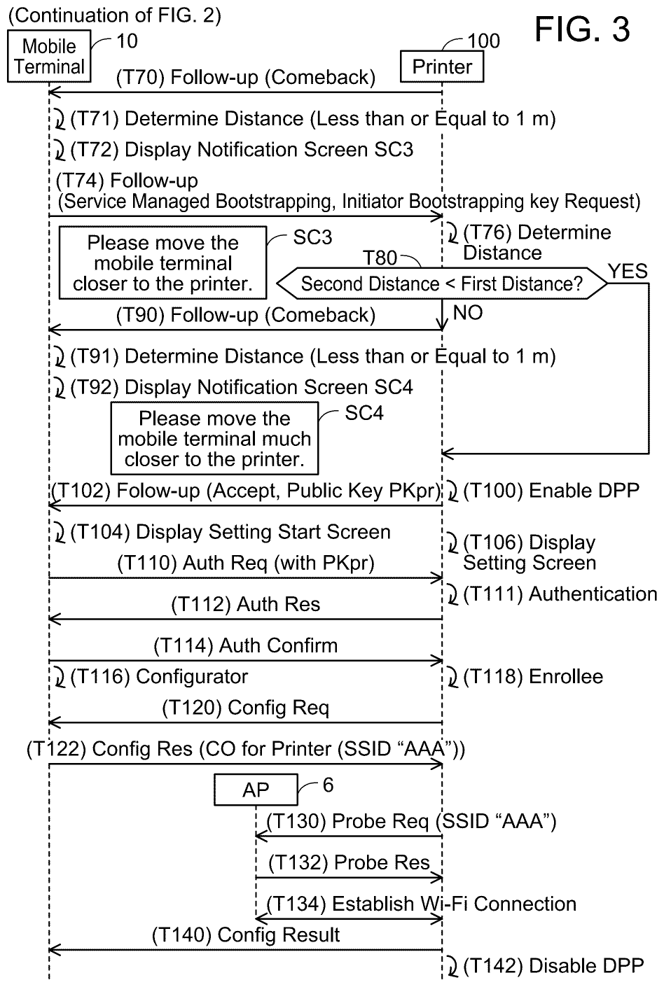

In T50, the printer 100 determines whether the distance determined in T44 is equal to or less than a predetermined distance of 1 meter. It should be noted that the predetermined distance of 1 meter is merely an example, and the predetermined distance may be less than 1 meter or more than 1 meter. The predetermined distance is less than the maximum distance with which the printer 100 can communicate with the mobile terminal 10 via the Wi-Fi I/F 118 (e.g., 50 to 100 meters). When the determined distance is equal to or less than 1 meter (YES in T50), the printer 100 proceeds to T70 in FIG. 3 without executing T60 and T62, whereas when the determined distance is more than 1 meter (NO in T50), the printer 100 proceeds to T60.

In T60, the printer 100 sends a Follow-up conforming to the Wi-Fi Aware scheme to the mobile terminal 10. This Follow-up includes Comeback information. The Comeback information is a signal that requests the mobile terminal 10 to resend the wireless connection start request.

In response to receiving the Follow-up including the Comeback information from the printer 100 in T60, the mobile terminal 10 identifies the signal strength of the received Follow-up and determines the distance between the printer 100 and the mobile terminal 10 based on the signal strength. Specifically, the terminal device 10 stores in advance a formula for determining a distance based on a signal strength and plugs the signal strength into the formula to determine the distance. The mobile terminal 10 then determines whether the distance is equal to or less than 1 meter.

The distance is more than 1 meter at the time of T61, and thus the mobile terminal 10 displays a notification screen SC2 on the display unit 14 in T62. The notification screen SC2 prompts the user to come much closer to the printer 100. Thus, the user can become aware that he/she should bring the mobile terminal 10 much closer to the printer 100. After displaying the notification screen SC2, the mobile terminal 10 returns to T42. That is, the sequence from T42 to T62 is repeated until the distance between the mobile terminal 10 and the printer 100 becomes equal to or less than 1 meter.

In T70, the printer 100 sends a Follow-up conforming to the Wi-Fi Aware scheme to the mobile terminal 10 in the same way as T60. This Follow-up includes Comeback information.

In response to receiving the Follo-up including the Comeback information from the printer 100 in T70, the mobile terminal 10 identifies the signal strength of the received Follow-up and determines the distance between the printer 100 and the mobile terminal 10 based on the signal strength. The mobile terminal 10 then determines whether the distance is equal to or less than 1 meter.

The distance is equal to or less than 1 meter at the time of T71, and thus the mobile terminal 10 displays a notification screen SC3 on the display unit 14 in T72. The notification screen SC3 prompts the user to bring the mobile terminal 10 closer to the printer 100. In T74, the mobile terminal 10 sends a Follow-up to the printer 100 in the same way as T42.

In response to receiving the Follow-up from the mobile terminal 10 in T74, the printer 100 determines in T76 the distance between the printer 100 and the mobile terminal 10 in the same way as T44.

In T80, the printer 100 determines whether the distance determined in T76 (termed “second distance” hereinafter) is smaller than the distance determined in T44 (termed “first distance” hereinafter). When the second distance is smaller than the first distance (YES in T80), the printer 100 proceeds to T100 without executing T90 and T92, whereas when the second distance is equal to or more than the first distance (NO in T80), the printer 100 proceeds to T90.

In T90, the printer 100 sends a Follow-up conforming to the Wi-Fi Aware scheme to the mobile terminal 10 in the same way as T60. This Follow-up includes Comeback information.

In response to receiving the Follow-up including the Comeback information from the printer 100 in T90, the mobile terminal 10 identifies the signal strength of the received Follow-up and determines the distance between the printer 100 and the mobile terminal 10 based on the signal strength. The mobile terminal 10 then determines whether the distance is equal to or less than 1 meter.

The distance is equal to or less than 1 meter at the time of T91 and the notification screen SC3 has been already displayed (T72), and thus the mobile terminal 10 displays a notification screen SC4 on the display unit 14 in T92 instead of the notification screen SC3. The notification screen SC4 prompts the user to bring the mobile terminal 10 much closer to the printer 100. Then, the mobile terminal 10 returns to T74 and sends a Follow-up to the printer 100. That is, the sequence from T74 to T92 is repeated until the distance between the mobile terminal 10 and the printer 100 (i.e., the second distance) becomes smaller than the first distance.

In T100, the printer 100 shifts from a DPP disabled state to a DPP enabled state. The DPP disabled state is a state where communications conforming to the DPP scheme are disabled. The DPP enabled state is a state where communications conforming to the DPP scheme are enabled. By shifting to the DPP enabled state, the printer 100 can execute communications confirming to the DPP scheme.

In T102, the printer 100 sends a Follow-up conforming to the Wi-Fi Aware scheme to the mobile terminal 10. This Follow-up includes Accept information and Bootstrapping key of the DPP scheme including a public key “PKpr” of the printer 100. The Accept information indicates that a sending request for Bootstrapping key has been accepted. The Bootstrapping key of the DPP scheme including the public key “PKpr” is written in extended information of the Follow-up. Hereinafter, the Bootstrapping key of the DPP scheme including the public key “PKpr” may be termed the public key “PKpr” for short.

In response to receiving the Follow-up including the Accept information and the public key “PKpr” from the printer 100 in T102, the mobile terminal 10 displays a setting start screen on the display unit 14 in T104. The connection start screen includes a message that establishment of a Wi-Fi connection between the printer 100 and the AP 6 is in progress.

In T106, the printer 100 displays a setting screen on the display unit 114. The setting screen includes a message that establishment of a Wi-Fi connection between the printer 100 and the AP 6 is in progress. Thus, the user can become aware that establishment of a Wi-Fi connection is in progress.

In T110, the mobile terminal 10 sends an Authentication Request confirming to the DPP scheme to the printer 100. The Authentication Request is a signal obtained by using the public key “PKpr”. Hereinafter, Authentication is abbreviated as “Auth” and Request is abbreviated as “Req”.

The Auth Req is a signal that requests authentication for the mobile terminal 10 which is the sender of the Auth Req. Specifically, the mobile terminal 10 creates a shared key by using a private key of the mobile terminal 10 and the public key “PKpr” of the printer 100 and then creates encrypted data by encrypting random values with the shared key. The mobile terminal 10 then sends the Auth Req conforming to the DPP scheme to the printer 100. The Auth Req incudes a public key of the mobile terminal 10, the encrypted data, and a Capability of the mobile terminal 10. The Capability of the mobile terminal 10 includes a value indicating that the mobile terminal 10 is capable of operating only as a Configurator of the DPP scheme.

In response to receiving the Auth Req from the mobile terminal 10 in T110, the printer 100 authenticates the encrypted data included in the Auth Req in T111. Specifically, the printer 100 creates a shared key by using the public key of the mobile terminal 10 included in the Auth Req and a private key of the printer 100 and decrypts the encrypted data with the shared key. When the encrypted data is successfully decrypted, the printer 100 determines that the authentication has succeeded and proceeds to executing a sequence from T112 onward.

In T112, the printer 100 sends an Auth Response including a Capability of the printer 100 to the mobile terminal 10 according to the DPP scheme. Hereinafter, Response is abbreviated as “Res”. The Capability of the printer 100 includes a value indicating that the printer 100 is capable of operating only as an Enrollee of the DPP scheme.

In response to receiving the Auth Res from the printer 100 in T112, the mobile terminal 10 determines that the Capability of the printer 100 included in the Auth Res (i.e., Enrollee) does not match the Capability of the mobile terminal 10 itself (i.e., Configurator). In T114, the mobile terminal 10 sends an Auth Confirm conforming to the DPP scheme to the printer 100. The Auth Confirm includes information indicating that the mobile terminal 10 operates as a Configurator and the printer 100 operates as an Enrollee. In T116, the mobile terminal 10 determines that it will operate as a Configurator. A Configurator is a device that plays a role in sending a Configuration Object (which will be described) to an Enrollee. Hereinafter, Configuration Object is abbreviated as “CO”.

In T118, the printer 100 determines that it will operate as an Enrollee. An Enrollee is a device that plays a role in receiving a CO from a Configurator. The sequence from T110 to T118 corresponds to Auth of the DPP scheme.

In T120, the printer 100 sends a Configuration Req conforming to the DPP scheme to the mobile terminal 10. Hereinafter, Configuration is abbreviated as “Config”. The Config Req is a signal that requests sending of a CO.

In response to receiving the Config Req from the printer 100 in T120, the mobile terminal 10 creates a printer CO. Specifically, the mobile terminal 10 creates a printer CO which is information to be used by the printer 100 to establish a Wi-Fi connection. The printer CO includes the SSID “AAA” and the PW “XXX” of the wireless network formed by the AP 6. In T122, the mobile terminal 10 sends a Config Res including the printer CO conforming to the DPP scheme to the printer 100.

In response to receiving the Config Res from the mobile terminal 10 in T122, the printer 100 sends a Probe Req including the SSID “AAA”, which was included in the printer CO conforming to the DPP scheme, by broadcasting in T130. The AP 6 receives the Probe Req.

In response to receiving the Probe Req from the printer 100 in T130, the AP 6 sends a Probe Res to the printer 100 in T132. As a result, a Wi-Fi connection is established between the printer 100 and the AP 6 in T134. T130 and T132 correspond to Network Access of the DPP scheme.

In T140, the printer 100 sends a Config Result conforming to the DPP scheme to the mobile terminal 10. The Config Result includes information indicating that the Wi-Fi connection has been established between the printer 100 and the AP 6. T120, T122, and T140 correspond to Config of the DPP scheme. In T142, the printer 100 shifts from the DPP enabled state to the DPP disabled state.

As described above, a Wi-Fi connection is established between the printer 100 and the AP 6 by the mobile terminal 10 and the printer 100 executing various communications according to the DPP scheme therebetween. Then, the printer 100 joins, as a child station, the wireless network in which the AP 6 is operating as the parent station. As a result, the mobile terminal 10 and the printer 100 both belong to the wireless network formed by the AP 6.

### Advantageous Effects of First Embodiment

According to the configuration described above, the printer 100 sends a Publish indicating that the printer 100 is capable of using the DPP scheme to the mobile terminal 10 according to the W-Fi Aware (T32). Thus, the mobile terminal 10 can recognize, via the Wi-Fi I/F 18, that the printer 100 is capable of executing communications according to the DPP scheme when a Wi-Fi connection is not established yet. Further, the printer 100 sends a Follow-up including the public key “PKpr” of the printer 100 conforming to the DPP scheme to the mobile terminal 10 according to the Wi-Fi Aware (T102) and executes communications with the mobile terminal 10 according to the DPP scheme (T110, T112, and T122). A Wi-Fi connection can thereby be established between the printer 100 and the AP 6 according to the DPP scheme. Further, since the use of the Wi-Fi Aware scheme ensures a close-range communication, the printer 100 can send its public key to the mobile terminal 10 in a more secure manner than communicating with a communication terminal whose physical location is unclear.

According to the configuration described above, the printer 100 sends Publish indicating that the printer 100 is capable of using the DPP scheme to the mobile terminal 10 according to the Wi-Fi Aware scheme (T32) before a wireless connection of the Wi-Fi standard is established. The mobile terminal 10 can thus recognize that the printer 100 is capable of executing communications according to the DPP scheme. Further, the printer 100 sends a Follow-up including the public key “PKpr” of the printer 100 conforming to the DPP scheme to the mobile terminal 10 according to the Wi-Fi Aware scheme (T102) and executes communications with the mobile terminal 10 according to the DPP scheme (T110, T112, and T122). A Wi-Fi connection can thereby be established between the printer 100 and the AP 6 according to the DPP scheme.

According to the configuration described above, the mobile terminal 10 receives a Publish indicating that the printer 100 is capable of using the DPP scheme from the printer 100 according to the Wi-Fi Aware scheme (T32). Thus, the mobile terminal 10 can recognize that the printer 100 is capable of executing communications according to the DPP scheme. Further, the mobile terminal 10 receives a Follow-up including the public key “PKpr” of the printer 100 conforming to the DPP scheme from the printer 100 according to the Wi-Fi Aware scheme and executes communications with the printer 100 according to the DPP scheme (T110, T112, and T122). A Wi-Fi connection can thereby be established between the printer 100 and the AP 6 according to the DPP scheme.

According to the configuration described above, the printer 100 determines the distance between the printer 100 and the mobile terminal 10 based on the signal strength of a received signal (T44). When the determined distance is equal to or less than 1 meter (YES in T50), the printer 100 sends a Follow-up including the public key “PKpr” to the mobile terminal 10 (T102), whereas when the determined distance is more than 1 meter (NO in T50), the printer 100 does not send a Follow-up including the public key “PKpr” to the mobile terminal 10. Thus, the printer 100 can determine whether a Follow-up including the public key “PKpr” is to be sent to the mobile terminal 10 or not based on the distance from the mobile terminal 10. That is, the printer 100 sends its public key only to mobile terminals (e.g., the mobile terminal 10) that are physically present within a distance via which the printer 100 can be manipulated (i.e., 1 meter) but does not send its public key to mobile terminals that are not physically present within that distance (i.e., 1 meter). Thus, the printer 100 can exclude manipulations from mobile terminals that present far away from the printer 100. In other words, the printer 100 can assume that the user of the mobile terminal 10 has intentionally approached the printer 100 to exclude unexpected communications with mobile terminals that are present far away from the printer 100. Thus, the printer 100 can communicate only with reliable communication partners.

According to the configuration described above, the printer 100 determines in T80 whether the distance determined in T76 (i.e., the second distance) is smaller than the distance determined in T50 (i.e., the first distance). When the second distance is smaller than the first distance (YES in T80), the printer 100 sends a Follow-up including the public key “PKpr” to the mobile terminal 10 (T102). When the second distance is equal to or more than the first distance (NO in T80), the printer 100 does not send a Follow-up including the public key “PKpr” to the mobile terminal 10. Thus, when the mobile terminal 10, which is present within 1 meter from the printer 100, comes much closer to the printer 100, the printer 100 sends a Follow-up including the public key “PKpr” to the mobile terminal 10. This configuration allows the printer 100 to appropriately send the public key “PKpr” to the mobile terminal 10 even when multiple mobile terminals are present within 1 meter from the printer 100. In other words, the printer 100 can specify the mobile terminal 10 to be used to establish a wireless connection conforming to the DPP scheme (T80) and send the public key “PKpr” to the mobile terminal 10.

### Correspondence Relationships

The printer 100, the mobile terminal 10, and the AP 6 are examples of “communication device”, “terminal device”, and “external device”, respectively. A Publish indicating a device is capable of providing the DPP service is an example of “capable information”. The public key “PKpr” and the printer CO are examples of “relation information” and “connection information”, respectively. The Wi-Fi connection between the printer 100 and the AP 6 is an example of “first wireless connection”. The distance determined in T44 of FIG. 2 is an example of “first distance”. One meter is an example of “predetermined distance”. The distance determined in T76 of FIG. 3 is an example of “second distance”. The Follow-up in T42 is an example of “request signal”.

T32 in FIGS. 2 and T102 in FIG. 3 are examples of “send capable information” and “send relation information”, respectively. The combination of T110, T112, and T122 in FIG. 3 is an example of “execute a first communication”. T134 is an example of “establish a first wireless connection”. T44 in FIGS. 2 and T76 in FIG. 3 are examples of “determine a first distance” and “determine a second distance”, respectively. T42 in FIG. 2 is an example of “receive a request signal”. T100 in FIG. 3 is an example of “shift a state of the communication device”.

T32 in FIGS. 2 and T102 in FIG. 3 are examples of “receive capable information” and “receive relation information”, respectively.

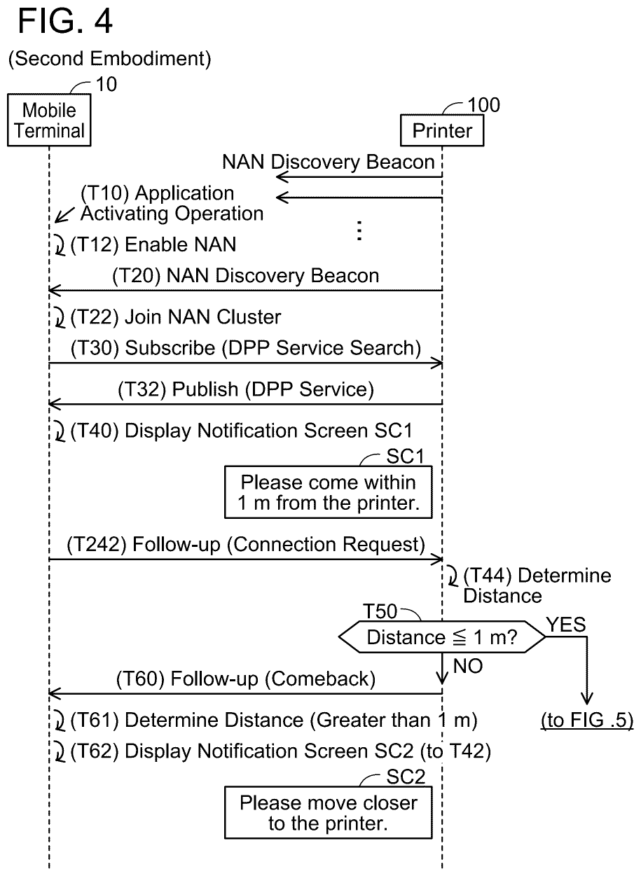

### Second Embodiment: FIG. 4

Referring to FIG. 4, a second embodiment is described. This embodiment is different from the first embodiment in that a wireless connection is established between the printer 100 and the mobile terminal 10 and that the public key “PKpr” is sent using that wireless connection.

The same sequence from T10 to T40 in FIG. 2 is executed. At the same time as the display of the notification screen SC1 in T40, the mobile terminal 10 sends a Follow-up conforming to the Wi-Fi Aware scheme to the printer 100 in T242. This Follow-up includes a connection request that requests establishment of a wireless connection with the mobile terminal 10. The Follow-up is a signal communicated by using lower layers than the network layer of the OSI model. Then, the same sequence from T44 in FIGS. 2 to T92 in FIG. 3 is executed.

In T300, the printer 100 sends a Follow-up conforming to the Wi-Fi Aware scheme to the mobile terminal 10. This Follow-up includes Accept information and a connection response. The Accept information indicates that the connection request has been accepted. The connection response is written in extended information of the Follow-up. In T302, pairing is executed between the mobile terminal 10 and the printer 100. The pairing is also executed by using lower layers than the network layer of the OSI model.

By the pairing with the mobile terminal 10, the printer 100 establishes a wireless connection with the mobile terminal 10 according to the Wi-Fi Aware scheme via the Wi-Fi I/F 118 in T304. Communication executed by using this wireless connect is so-called NAN Date Path (NDP). The NDP is communication for applications conforming to NAN standard. The printer 100 can thus execute secure communications with the mobile terminal 10.

In T306, the printer 100 sends the public key “PKpr” to the mobile terminal 10 by using the wireless connection established in T304 (i.e., using the NDP). Then, the printer 100 shifts from the DPP disabled state to the DPP enabled state in T310. By shifting to the DPP enabled state, the printer 100 can execute communications according to the DPP scheme. Then, the same sequence from T104 to T142 in FIG. 3 is executed. In this sequence, communications of T110, T112, T114, T120, T122, and T140 are executed by using the wireless connection established in T304 (i.e., using the NDP).

### Advantageous Effects of Second Embodiment

In this embodiment, the pairing is executed between the mobile terminal 10 and the printer 100 to establish a wireless connection between the mobile terminal 10 and the printer 100 according to the Wi-Fi Aware scheme (T304). This allows the mobile terminal 10 and the printer 100 to execute communications therebetween using the network layer and upper layers of the OSI model. By using the wireless connection, the printer 100 can securely send the public key “PKpr” to the mobile terminal 10.

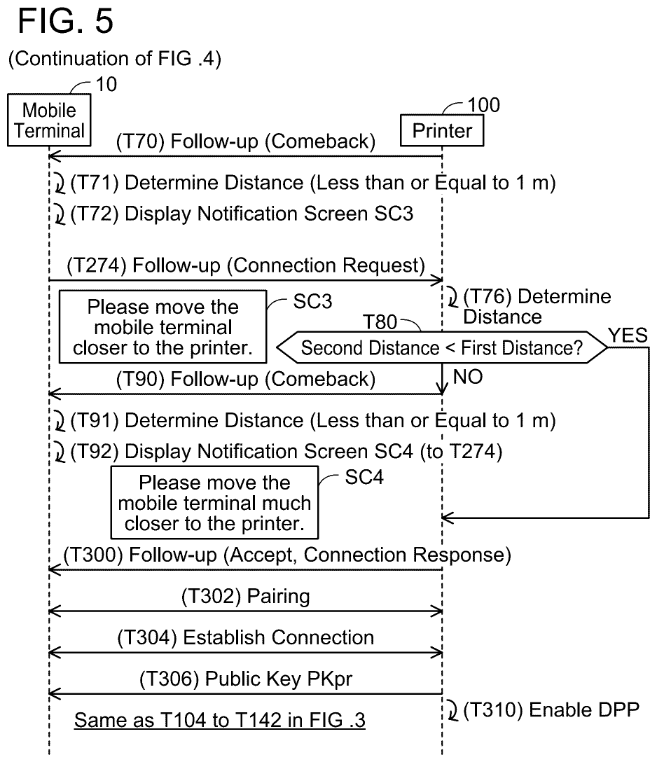

Further, the printer 100 executes communications with the mobile terminal 10 according to the DPP scheme by using the wireless connection (T110, T112, T122 in FIG. 3 referenced in FIG. 5). A Wi-Fi connection is thereby established between the printer 100 and the AP 6 (T134 in FIG. 3 referenced in FIG. 5). In this embodiment, the wireless connection in T304 is an example of “second wireless connection”, and T304 in FIG. 5 is an example of “establish a second wireless connection”.

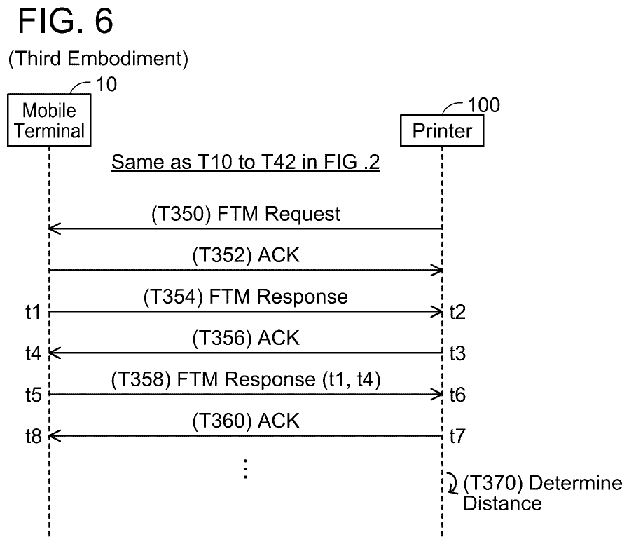

### Third Embodiment: FIG. 6

Referring now to FIG. 6, a third embodiment is described. This embodiment is different from the first and second embodiments in the way of determining the distance between the printer 100 and the mobile terminal 10.

The same sequence from T10 to T42 in FIG. 2 is executed. Then, the printer 100 sends a Fine Timing Measurement (FTM) request to the mobile terminal 10 in T350. The FTM is a method for measuring the distance between devices via the Wi-Fi I/F 118. The FTM request is a signal that requests the FTM to be started and includes, for example, information on frequency bands used in various communications for the FTM.

In response to receiving the FTM request from the printer 100 in T350, the mobile terminal 10 sends an ACK to the printer 100 in T352. As a result, the FTM is started from T354.

In the FTM, the mobile terminal 10 first sends an FTM response to the printer 100 in T354. At this time, the mobile terminal 10 stores a time t1 at which the FTM response was sent.

The printer 100 receives the FTM response from the mobile terminal 10 in T354. At this time, the printer 100 stores a time t2 at which the FTM response was received. Then, the printer 100 sends an ACK to the mobile terminal 10 in T356. At this time, the printer 100 stores a time t3 at which the ACK was sent.

The mobile terminal 10 receives the ACK from the printer 100 in T356. At this time, the mobile terminal 10 stores a time t4 at which the ACK was received.

Then, the mobile terminal 10 sends an FTM response to the printer 100 in T358. This FTM response includes the stored time t1 and time t4. Further, the mobile terminal 10 stores a time t5 at which the FTM response was sent in T358.

The printer 100 receives the FTM response from the mobile terminal 10 in T358. At this time, the printer 100 stores a time t6 at which the FTM response was received.

In T370, the printer 100 calculates the distance between the printer 100 and the mobile terminal 10 by using the stored time t2 and time t3 as well as the time t1 and time t4 included in the FTM response in T358. Specifically, the printer 100 first calculates RTT1=(t4−t1)−(t3−t2), where RTT1 is a sum of a time period taken to send the FTM response in T354 and a time period taken to send the ACK in T356. That is, RTT1 is a time period taken for one cycle of communication between the printer 100 and the mobile terminal 10. Then, the printer 100 calculates the distance between the printer 100 and the mobile terminal 10 by using a formula ((c×RTT1)/2), where c is light speed. Thus, the printer 100 can calculate the distance between the printer 100 and the mobile terminal 10 by using the time t1 and time t2 related to the communication of the FTM response and the time t3 and time t4 related to the communication of the ACK.

The printer 100 sends an ACK to the mobile terminal 10 in T360. At this time, the printer 100 stores a time t7 at which the ACK was sent.

The mobile terminal 10 receives the ACK from the printer 100 in T360. At this time, the mobile terminal 10 stores a time t8 at which the ACK was received.

Thereafter, the printer 100 and the mobile terminal 10 repeat communicating an FTM response and an ACK a predetermined number of times. The printer 100 calculates the distance between the printer 100 and the mobile terminal 10 for each cycle of communication for FTM response and ACK. For example, for a cycle of communication for the FTM response in T358 and the ACK in T360, the distance between the printer 100 and the mobile terminal 10 is calculated by using a formula (cxRTT2)/2), where RTT2=(t8−t5)−(t7−t6). In T370, the printer 100 calculates an average of the distances calculated the predetermined number of times to determine the distance between the printer 100 and the mobile terminal 10.

### Advantageous Effects of Third Embodiment

According to the configuration described above, after the printer 100 has sent a Publish indicating that the printer 100 is capable of using the DPP scheme to the mobile terminal 10 according to the Wi-Fi Aware scheme (T30 in FIG. 2 referenced in FIG. 6), the printer 100 receives an FTM response from the mobile terminal 10 (T354) and sends an ACK to the mobile terminal 10 (T356). The printer 100 can thereby appropriately determine the distance between the printer 100 and the mobile terminal 10 based on the times related to these signals (T370). In this embodiment, the FTM response in T354 and the ACK in T356 are examples of “first signal” and “second signal”, respectively. The combination of T354 and T356 is an example of “execute a second communication”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification 1

In T102 of FIG. 3, the printer 100 may receive a push button operation from the user without sending the Follow-up to the mobile terminal 10. In response to the push button operation, the printer 100 receives a DPP start instruction. The mobile terminal 10 may also receive a DPP start instruction in response to receiving a push button operation from the user. The mobile terminal 10 sends a code exchange request including a code element Qa created, an information element M, and an identifier of the mobile terminal 10 (e.g., its MAC address) to the printer 100. As a result, an authentication phase of public key exchange protocol by the IETF draft is started. After this, the mobile terminal 10 and the printer 100 execute a predetermined communication to share a shared key Z. Then, a reveal phase of public key exchange protocol by the IETF draft is started. The mobile terminal 10 and the printer 100 execute Public Key Exchange (PKEX) by using the shared key Z and an authentication public key to share their public keys. That is, the mobile terminal 10 can acquire the public key “PKpr” of the printer 100. In this modification, the authentication public key is an example of “relation information”.

### Modification 2

After the Follow-up conforming to the Wi-Fi Aware scheme has been communicated in T300 of FIG. 5, the mobile terminal 10 or the printer 100 may display a screen including a message that asks whether pairing is to be executed or not. In response to receiving a pairing operation from the user, the mobile terminal 10 and the printer 100 may execute pairing.

### Modification 3

The public key “PKpr” may be included in the Subscribe of T30 in FIG. 2. In this case, T32 in FIG. 2 is an example of “send relation information”. That is, in this modification, “send capable information” and “send relation information” are executed simultaneously.

### Modification 4

T30 in FIG. 2 may be omitted. That is, the mobile terminal 10 may receive a Publish from the printer 100 without sending a Subscribe.

### Modification 5

The printer 100 may establish a Wi-Fi connection with a device different from the AP 6, which is for example, a mobile terminal other than the mobile terminal 10. In this modification, the device different from the AP 6 is an example of “external device”.

### Modification 6

In T44 of FIGS. 2 and T76 of FIG. 3, the printer 100 may execute communication with the mobile terminal 10, for example, according to the Bluetooth (registered trademark) scheme and determine the distance between the mobile terminal 10 and the printer 100 based on the signal strength of the Bluetooth signal. That is, the printer 100 may determine the distance based on the signal strength of a signal conforming to a communication scheme different from the Wi-Fi scheme. In another example, the printer 100 may receive a Follow-up including GPS information of the mobile terminal 10 from the mobile terminal 10. In this case, the printer 100 may determine the distance between the mobile terminal 10 and the printer 100 based on GPS information of the printer 100 and the GPS information of the mobile terminal 10. In yet another example, the printer 100 may receive a Follow-up including the distance between the mobile terminal 10 and the printer 100 determined by the mobile terminal 10 from the mobile terminal 10. That is, the printer 100 may determine the distance by acquiring it from the mobile terminal 10 without calculating the distance by itself.

### Modification 7

The sequence from T44 in FIGS. 2 to T92 in FIG. 3 may be omitted. In this case, in response to receiving a Follow-up from the mobile terminal 10 in T42. The printer 100 sends a Follow-up including the public key “PKpr” to the mobile terminal 10 in T102 without determining the distance between the mobile terminal 10 and the printer 100. In this modification, “determine a first distance” and “determine a second distance” may be omitted.

### Modification 8

T100 in FIG. 3 may be omitted. In this case, the printer 100 is already in the DPP enabled state in the initial state in FIG. 2. In this modification, “shift a state of the communication device”.

### Modification 9

T110, T112, and T122 in FIG. 3 referenced in FIG. 5 may be executed without using the wireless connection established in T304. That is, the wireless connection established in T304 may be disconnected after the public key “PKpr” has been sent from the printer 100 to the mobile terminal 10 in T306.

### Modification 10

Instead of the sequence from T10 in FIGS. 2 to T106 in FIG. 3, the printer 100 may send a service discovery response in response to receiving a service discovery request conforming to a WFD (Wi-Fi Direct) scheme from the mobile terminal 10. The service discovery response includes capable information indicating that the printer 100 is capable of using the DPP scheme. By receiving the service discovery response including the capable information from the printer 100, the mobile terminal 10 can recognize that the printer 100 is capable of executing communications according to the DPP scheme. Then, the printer 100 may send the public key “PKpr” of the printer 100 conforming to the DPP scheme to the mobile terminal 10 via a connection according to the WFD scheme. Generally, “capable information” may be sent before a wireless connection of the Wi-Fi standard is established. Further, “relation information” may be sent via the Wi-Fi interface. In other words, “relation information” may be sent by using a communication of the Wi-Fi standard. In another example, the printer 100 may send a beacon signal conforming to the Wi-Fi standard. The beacon signal includes capable information indicating that the printer 100 is capable of using the DPP scheme. By receiving the beacon signal including the capable information from the printer 100, the mobile terminal 10 can recognize that the printer 100 is capable of executing communications according to the DPP scheme. Then, the printer 100 may send the public key “PKpr” of the printer 100 conforming to the DPP scheme to the mobile terminal 10 by using a communication according to the Wi-Fi standard.

### Modification 11

In the above embodiments, each step in FIGS. 2 to 6 is implemented by software (e.g., the program 140 in the printer 100, the OS program 40 in the mobile terminal 10), however, at least one of the steps may be implemented by hardware such as a logic circuit.

What is claimed is:

1. A communication device comprising:
a Wi-Fi interface; and
a controller,
wherein the controller is configured to:
send capable information indicating that the communication device is capable of using a Device Provisioning Protocol (DPP) scheme of a Wi-Fi standard to a terminal device via the Wi-Fi interface according to a Wi-Fi Aware scheme of the Wi-Fi standard;
send relation information related to a public key of the communication device conforming to the DPP scheme to the terminal device via the Wi-Fi interface according to the Wi-Fi Aware scheme;
execute a first communication with the terminal device according to the DPP scheme after the capable information has been sent to the terminal device and the relation information has been sent to the terminal device, the first communication including a communication of an authentication request obtained by using the public key from the terminal device to the communication device, a communication of an authentication response from the communication device to the terminal device, and a communication of connection information from the terminal device to the communication device; and
in a case where the connection information is received from the terminal device, establish a first wireless connection between the communication device and an external device via the Wi-Fi interface by using the connection information.

2. The communication device as in claim 1,
wherein the controller is further configured to:
determine a first distance between the terminal device and the communication device,
wherein in a case where the first distance is less than or equal to a predetermined distance, the controller sends the relation information to the terminal device, and
in a case where the first distance is greater than the predetermined distance, the controller does not send the relation information to the terminal device.

3. The communication device as in claim 2,
wherein the controller is further configured to:
determine a second distance between the terminal device and the communication device after the first distance has been determined,
wherein in a case where the first distance is less than or equal to the predetermined distance and the second distance is less than the first distance, the controller sends the relation information to the terminal device, and
in a case where the first distance is less than or equal to the predetermined distance and the second distance is greater than or equal to the first distance, the controller does not send the relation information to the terminal device.

4. The communication device as in claim 2,
wherein the controller is further configured to:
receive a request signal that requests sending of the public key from the terminal device via the Wi-Fi interface after the capable information has been sent to the terminal device, and
the controller determines the first distance based on a signal strength of the received request signal.

5. The communication device as in claim 2,
wherein the controller is further configured to:
execute a second communication with the terminal device via the Wi-Fi interface after the capable information has been sent to the terminal device, the second communication including receipt of a first signal from the terminal device and sending of a second signal to the terminal device, and
the controller determines the first distance based on a time related to the first signal and a time related to the second signal.

6. The communication device as in claim 2,
wherein the controller is further configured to:
in a case where the first distance is less than or equal to the predetermined distance after the capable information has been sent to the terminal device, shift a state of the communication device from a disabled state where a communication according to the DPP scheme is disabled to an enabled state where a communication according to the DPP scheme is enabled.

7. The communication device as in claim 1,
the controller sends the terminal device a Publish that includes the capable information and conforms to the Wi-Fi Aware scheme, and
the controller sends the terminal device a Follow-up signal that includes the relation information and conforms to the Wi-Fi Aware scheme.

8. The communication device as in claim 1,
wherein the controller is further configured to:
establish a second wireless connection according to the Wi-Fi Aware scheme with the terminal device via the Wi-Fi interface after the capable information has been sent to the terminal device, and
the controller sends the relation information to the terminal device by using the second wireless connection.

9. The communication device as in claim 1,
the controller executes the first communication with the terminal device by using the second wireless connection.

10. A non-transitory computer-readable recording medium storing computer-readable instructions for a terminal device,
wherein the terminal device comprises a Wi-Fi interface, and
the computer-readable instructions, when executed by a processor of the terminal device, cause the terminal device to:
receive capable information indicating that a communication device is capable of using a Device Provisioning Protocol (DPP) scheme of a Wi-Fi standard from the communication device via the Wi-Fi interface according to a Wi-Fi Aware scheme of the Wi-Fi standard;
receive relation information related to a public key of the communication device conforming to the DPP scheme from the communication device via the Wi-Fi interface according to the Wi-Fi Aware scheme;
execute a first communication according to the DPP scheme with the communication device after the capable information has been received from the communication device and the relation information has been received from the communication device, the first communication including a communication of an authentication request obtained by using the public key from the terminal device to the communication device, a communication of an authentication response from the communication device to the terminal device, and a communication of connection information from the terminal device to the communication device, the connection information being used for establishing a wireless connection between the communication device and an external device.

11. A communication device comprising:
a Wi-Fi interface; and
a controller,
wherein the controller is configured to:
send capable information indicating that the communication device is capable of using a Device Provisioning Protocol (DPP) scheme of a Wi-Fi standard to a terminal device via the Wi-Fi interface before a wireless connection of the Wi-Fi standard is established;
send relation information related to a public key of the communication device conforming to the DPP scheme to the terminal device via the Wi-Fi interface;
execute a first communication with the terminal device according to the DPP scheme after the capable information has been sent to the terminal device and the relation information has been sent to the terminal device, the first communication including a communication of an authentication request obtained by using the public key from the terminal device to the communication device, a communication of an authentication response from the communication device to the terminal device, and a communication of connection information from the terminal device to the communication device; and
in a case where the connection information is received from the terminal device, establish a first wireless connection between the communication device and an external device via the Wi-Fi interface by using the connection information.
